(19) United States
(12) Patent Application Publication
(10) Pub. No.: US 2005/0079340 A1
(43) Pub. Date: Apr. 14, 2005

(54) Optically active film composite

(76) Inventors: Steven Allen Barth, Martinsville, VA (US); Anthony B. Port, Collinsville, VA (US); Janet S. Yeatts, Ruffin, NC (US)

Correspondence Address: FITZPATRICK CELLA HARPER & SCINTO, 30 ROCKEFELLER PLAZA, NEW YORK, NY, 10112, US

(21) Appl. No.: 10/670,359

(22) Filed: Sep. 26, 2003

Related U.S. Application Data
(63) Continuation-in-part of application No. 09/878,940, filed on Jun. 13, 2001, now Pat. No. 6,663,950.
Application No. 09/878,940 is a continuation-in-part of application No. 09/712,569, filed on Nov. 14, 2000, now abandoned.

(51) Int. Cl. B32B 5/16

(52) U.S. Cl. 428/323; 428/332; 428/336; 428/411.1

(57) ABSTRACT

A transaction card includes an optically active film composite comprising a PET polymeric film substrate covered with a hard coat layer of resin having a thickness of less than 6 microns, and a pencil hardness of at least 2H, the hard coat including a polymeric resin binder with nanoparticles of Lanthanum hexaboride absorbing light having a wavelength in the range of 700-1100 nm. The composite preferably has a VLT of about 50% and a transmission in the near IR wavelength of less than 10%.

### FIELD

This invention relates to optically active transparent composites and in particular to composites used for the shielding of infrared heat energy and uv radiation. Such composites may be used for the manufacture of ATM transaction cards.

### BACKGROUND OF THE INVENTION

Traditional banking and credit cards are opaque to visible light by virtue of the pigmentation in the plastics materials used in the manufacture of the cards, or by virtue of the use of inks, dyes, and metallised foils. To be useful in operation with an ATM ( Automatic Teller Machine) transaction cards need to be opaque to near infrared radiation since the machines use IR lasers operating within the range of 800-1000 nm to sense the presence of a card and activate the transaction process. The traditional cards cards are sufficiently opaque in the near IR to allow their use in ATM's.

The industry specification for the opacity of credit cards has been set at an optical density of 1.3 ( 5% transmission) for wavelengths upto 950 nm and at 1.1 ( 8% transmission) over 950-1000 nm.

Credit and transaction cards that are transparent over the visible light wavelengths of 400-700 nm have become fashionable due to the aesthetic design possibilities of such cards. The cards however still need to be opaque in the near IR wavelengths in order that the cards remain useable in ATM's.

One method of providing an IR opaque transaction card is disclosed in U.S. Pat. No. 6,290,137 in which the card includes a transparent sheet material which is coated near IR light filter, typically a dye which is applied by silk screen printing.

It is known that nanoparticles of various inorganic metal compounds, in particular oxides, can be dispersed within a resin binder to form coatings that reflect or absorb particular wavelength bands of infrared energy and allow high levels of transmission of visible light. In particular U.S. Pat. No. 5,807,511 discloses that antimony doped tin oxide (ATO) has a very low transmission to infrared light having a wavelength exceeding 1400 nm, and from U.S. Pat. No. 5,518,810 it is known that coatings containing tin doped indium oxide (ITO) particles also substantially block infrared light with having wavelength above 1000 nm, but the crystal structure of ITO can be modified to block light having wavelengths of down to 700-900 nm.

U.S. Pat. No. 6,060,154 discloses the use of fine particles of ruthenium oxide, tantalum nitride, titanium nitride, titanium silicide, molybdenum silicide and lanthanum boride to block light in the near infrared range. It also discloses the use of a plurality of different films each selectively transmitting light.

EP-A-739272 discloses a typical transparent polymeric film having uv absorbing properties.

EP-A-1008564 discloses the use of an infrared blocking coating composition which contains both ATO or ITO, and metal hexaboride. The ATO or ITO blocks the higher wavelengths of infrared light and the hexaboride particles block the lower wavelengths of light. The coating may be applied to polymeric film substrates.

The present invention seeks to provide a transparent film composite having visible light transmission and which shields against infrared light over the 800-1000 nm range and a composite including said film

### STATEMENTS OF INVENTION

According to the present invention there is provided for use in a transaction card, an optically active film composite and which includes a transparent film substrate having a hard coat layer on at least one surface thereof, the hard coat layer comprising a resin binder having a thickness of less than 6 microns and a pencil hardness of at least 2H, preferably 3H, and including 7-8% by weight of nanoparticles of Lanthanum Hexaboride.

The coating may also include a further metallic compound absorbing light having a wavelength in the range of 1000-2500 nm.

Preferably the composite has a VLT (visible light transmission) of about 50%, and blocks the near IR transmission to less than 10%, more preferably to between 5-8%.

Pencil hardness is measured according to ASTM D3363-92a.

VLT is visible light transmission calculated using CIE Standard Observer (CIE 1924 1931) and D65 Daylight.

Nanoparticles are particles having an average particle diameter 200 nm or less, and preferably less than 100 nm.

Preferably, said further metallic compound is Antimony Tin Oxide (ATO), Indium Tin Oxide (ITO), or Tin Oxide, more preferably ATO and the layer may contain 30-60% by weight of ATO, preferably 50-60% by weight of ATO.

The binder may be a thermoplastic resin such as an acrylic resin, a thermosetting resin such as an epoxy resin, an electron beam curing resin , or preferably a uv curable resin which may be an acrylate resin of the type disclosed in U.S. Pat. No. 4,557,980, or preferably a urethane acrylate resin.

The polymeric transparent film substrate may comprise polyethyleneterephthalate film (PET film), or polyvinyl chloride film. The PET film may include at least one uv radiation absorbing material to block out substantially all uv radiation to less than 1% weighted UV transmission.

Weighted UV transmission is derived from measurements made in accordance with ASTM E-424 and as modified by the Association of Industrial Metallisers, Coaters & Laminators (AIMCAL).

The film substrate may have a hard coat layer on both surfaces of said film.

The composite may further include at least one further polymeric transparent film layer, which may be laminated over one or both hard coat layers. The further polymeric film layer may comprise polyvinylchloride (PVC) film.

The PVC film layer may adhered to the hard coat layer, preferably using a pressure sensitive adhesive and a further PVC layer may be laminated over said adhered PVC film layer, preferably by hot lamination.

A card according to the present invention may be utilised in any automatic machine which uses the blocking of near IR radiation during its process initiation.

According to another aspect of the invention there is provided a transaction card including an optically active film composite including a polymeric film substrate having at least one surface thereof, and preferably both surfaces coated with a layer of resin having a thickness of less than 6 microns, the resin including nanoparticles of Lanthanum hexaboride absorbing light having a wavelength in the range of 700-1100 nm, the composite having a VLT of about 50% and a % tranmission of light at 940 nm wavelength of no more than 10%.

A further aspect of the invention provides a transaction card having an optically active film composite including a transparent polymeric film substrate, preferably PET, having at least one surface thereof, preferably both surfaces, coated with a layer of resin having a thickness of less than 6 microns and containing less than 10% by weight, preferably 7-8%, of nanoparticles of Lanthanum hexaboride absorbing light having a wavelength in the range of 700-1100 nm, with further transparent polymeric film layer, preferably PVC, laminated over said hardcoat layer so that said layer is sandwiched between the substrates and further film layer.

With the hardcoat resin layer located within the composite the optical properties of the layer are stabilized.

The composite is manufactured from a dispersion of nanoparticles of Lanthanum boride, absorbing light in the waveband 700-1100 nm, in a solution of polymeric resin, which is mixed in a liquid compatable with said solution, the liquid mixture being coated as a thin layer on a substrate and dried to form said hard coat. The substrate is preferably PET film whose surface may be treated for adhesion of the layer. The coated film is dried by passing under UV lamps having a rating of at least 300 watts per inch at a linear speed of at least 50 ft per min.

The liquid mixture may be applied to the film by any suitable method for example roller coating in particular using gravure printing techniques, slot die coating, bar and blade coating.

Yet another aspect of the invention provides a transaction card comprising a film composite including a PET film substrate having both surfaces thereof coated with a layer of hardcoat resin, each hard coat layer being overlayered by a first PVC film layer which in turn is overlayered by a second PVC film layer so that each said hard coat layer is sandwiched between the PET substrate and said first PVC film layer.

### DESCRIPTION OF DRAWINGS

The invention will be described by way of examples and with reference to the accompanying drawings in which:

FIG. 1 is a schematic drawing of a first composite according to the present drawings,

FIG. 2 is a schematic drawing of a second composite according to the present invention, and

FIG. 3 is a schematic of a third composite according to the present invention.

### DETAILED DESCRIPTION OF THE INVENTION

In the present invention the film composites have lower %VLT properties and maximise the blocking of infra red radiation close to the visible range. In particular the blocking of radiation in the range 800-1000 nm to less than 10% transmission whilst maintaining a VLT of about 50% has been difficult to achieve.

The invention will be described below with reference to a number of examples prepared from the following materials:

Composition A: is a UV curable urethane acrylate solvent based coating containing about 30-40% ATO nanoparticles and supplied by Sumitomo Osaka Cement under the designation SHI-60

Composition B is a dispersion of 2.2% by weight of nanoparticles of an inorganic metallic compound which absorbs light in the range 700-1000 nm dispersed in toluene supplied by Sumitomo Metal Mining under the designation KHF-7S

Composition C is a 25% dispersion of ATO nanoparticles in toluene supplied by Sumitomo Metal Mining under designation FMF-3S

Composition D is UW curable polyacrylate coating composition as is described in U.S. Pat. No. 4,557,980.

PET Film is Melinex 454 surface treated PET from Dupont. The film may be treated with uv absorber as described in EP-A-739 274.

Preparation of IR Shielding Composites

Various coatings were prepared from the compositions A,B, C & D by mixing selected compositions with gentle stirring. Following complete addition the mixed compositions were stirred for a further 30 minutes.

The different coating formulations were applied to PET films by using wire wound rods (Myers rods) of different sizes to deposit a range of different thickness coatings on the PET film. The coated films were dried on a glass plate for 1 minute at 70 degrees centigrade and the coating cured under UV 300 Watt per inch lamps on a laboratory belt moving at 50 feet per minute.

The different formulations were tested for % VLT, % haze, Abrasion and pencil hardness.

Samples were tested for Haze using a Hunter Laboratories Ultrascan XE and calculated according to:
(Diffuse Transmittance/Total Transmittance)×100 over a light range of 380-780 nm.

Samples were also tested for Abrasion resistance (Abrasn.) using a Taber Abrader in accordance with ASTM D1044-93. Results are quoted as an increase in Haze after 100 cycles using CS10 wheels each loaded with 1 kg.

A number of composite samples as shown in FIG. 3 were prepared as described. FIG. 3 shows a composite 10 having a layer 11 of various formulations coated onto a PET substrate 12.

### EXAMPLE 1

Example 1 comprises samples for formulations of B and D. Different formulations were prepared by mixing D into B and the various formulations were coated onto 7 mil (175 micron) PET film. The optical properties are given in Table 1 below:

TABLE 1

| | Ratio | added | | | | |
|---|---|---|---|---|---|---|
| Sample | B:D by | Toluene | Myers | | | |
| No | wt. | pbr* | Rod# | DFT | % VLT | % Haze |
| 9 | 1:1 | 0 | 8 | 5.5 | 67 | 2.6 |
| 10 | 1:1 | 1 | 8 | 3.7 | 79 | 2.1 |
| Film | | | | | 86 | 0.8 |

*parts by weight resin

The data shows that the addition of B to D results in acceptable levels of % VLT but unacceptable haze levels haze.

### EXAMPLE 2

In example 2 material B was mixed with material D, material A, and/or material C to produce various formulations that achieve high blocking of near IR radiation at 940 nm, whilst having a greater than 50% VLT.

TABLE 9

| Sample | Ratio by wt. | Myers | | % | % | % |
|---|---|---|---|---|---|---|
| no | A:B:C:D | Rod | DFT μ | VLT | Haze | Trans |
| 20 | 0:2:0:1 | 4 | 1.85 | 64.7 | 3.07 | 16.2 |
| | | 6 | 2.77 | 58.4 | 3.43 | 8.12 |
| | | 8 | 3.69 | 43.6 | 5.52 | 3.67 |
| 21A | 0:3.1:1.6:0 | 8 | 2.76 | 54.9 | 1.33 | 6.7 |
| 21B | 0:3.1:1.8:1 | 8 | 2.76 | 54.6 | 1.34 | 7.36 |
| 21C | 0:3.1:2.0:1 | 8 | 2.76 | 56.8 | 1.10 | 8.29 |
| 21D | 0:3.1:1.4:1 | 8 | 2.77 | 54.8 | 1.3 | 6.59 |
| 21E | 0:1.9:1:0.24 | 8 | 1.83 | 56.2 | 1.13 | 5.69 |
| 21F | 0:2.5:2.6:1 | 8 | 2.75 | 58.2 | 1.14 | 7.07 |
| 22 | 1:1:0:0 | 6 | 2.11 | 61.6 | 1.57 | 11.00 |
| | | 8 | 2.81 | 52.9 | 1.69 | 6.55 |
| | | 10 | 3.52 | 46.9 | 1.81 | 3.14 |

It can be seen that the formulations containing material B (the near IR absorbing nanoparticle dispersion) when mixed with either A or C (containing ATO nanoparticles) and D, especially where the ratio of B to A or D is greater than 1:1 produces formulations that have % VLT of around 50% and transmissions at 940nm of less than 10% with acceptable haze properties. Generally an increase in the ratio of B:D produces a smaller percentage transmission at 940 nm.

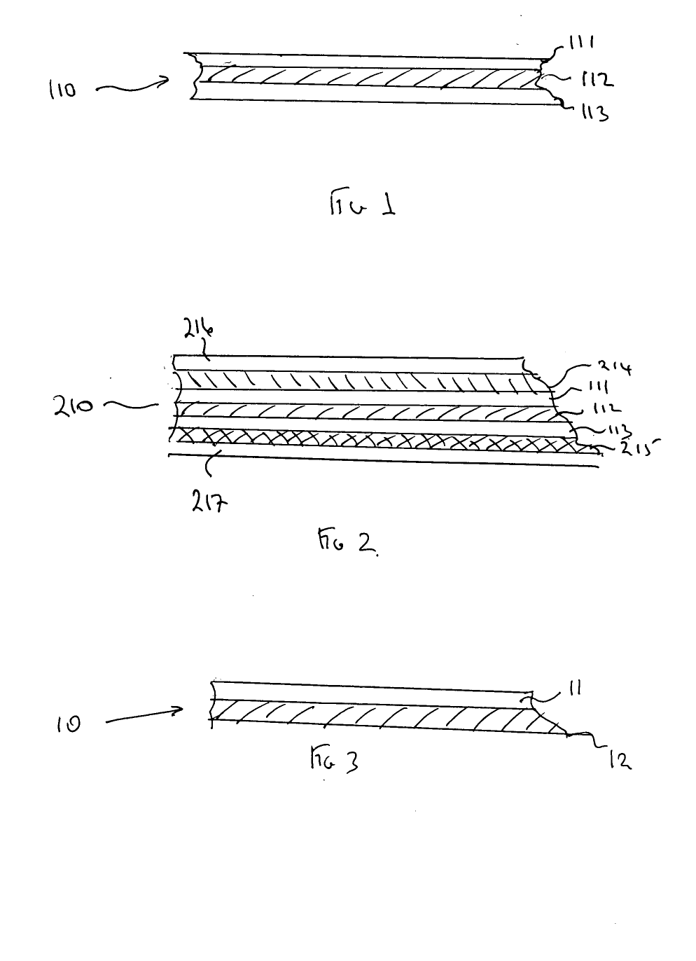

A second composite 110 shown in FIG. 1, comprises a 2 mil (50 microns) thick PET film 112 coated on each surface with a layer 111 or 113. The use of two coatings as shown in FIG. 1 has advantages over the composite 10 shown in FIG. 3 in that the composite 110 has an improved appearance and uniformity and the shrinkage stresses applied to the PET film 112 by the two coatings are balanced. When the composite 110 is used in the final manufacture of a transaction card its has a low tendency to curl or otherwise deform.

It has been found that Lanthanum Boride dispersion D is incompatible with acrylic acid giving rise the haze levels seen in Example 2.

The composition of the layers 111 & 113 is given in Example 3 below is based on composition D but with the acrylic acid removed to improve the haze properties.

### EXAMPLE 3

The composition of the layers 111,113 comprises B with a polyacrylate resin in a ratio of 6:1. The formulation of the layers is:

| | |
|---|---|
| Polyacrylate resin (Sartomer 295) | 2241 g |
| Composition B | 13512 g |
| Photoinitiator (Irgacure 184) | 225 g |

The coating material was applied to one surface of the PET using gravure coating techniques on a 24 inch wide coating line and dried at 65° C. and then UV cured. The coating was then applied to the other surface of the film. The coatings had a dry film thickness of between 3-4 microns.

The hard coat had a hardness of 2H and optical properties of the composite were as follows:

| | |
|---|---|
| % transmission at 800 nm | 5.0% |
| % transmission at 1000 nm | 2.5% |
| % VLT | 51% |
| % Haze | 1.0% |

The nanoparticles of Lanthanum hexaboride tend to colour the layers green. If other colours are desired, this can be achieved by using a dyed PET film substrate 112 in combination with the layers 111 & 113. The substrate film 112 is dyed using the trichromat dye system formulated to give the desired colour but then made deficient in green. This results in the desired end colour for the composite 110. This approach is described in U.S. Pat. No. 6,440,551. By using the above system a neutral grey film is achieved using a violet dyed PET film 112 in combination with the layers 111 & 113.

The composite 110 shown in FIG. 1 is incorporated into a composite 210 shown in FIG. 2 which is suitable for manufacture of a transaction card. The two IR blocking layers 111 113 are each over layered by a 4 mil PVC layer by adhesive lamination of the PVC layer. The final transaction card construction comprises two further PVC layers 216, 217. The layer 216, 217 comprise 10 mil PVC which is heat laminated to the layers 214, 215.

Credit or transaction cards made to the above construction with the PET film central layer 112 with the hard coating layers 111, 113 thereon, meet the standards of ISO/IEC 7810 for Physical Card Parameters.

When Credit cards of the above construction were tested by to Standard NCITS 322 the number of cycles to failure on the A axis ( across the width of the card) were 11500-18900 and the number of cycles to failure along the B axis ( along the length of the card ) were 61800 to >100,000.

A standard all PVC layer card would have similar properties in the A axis but significantly inferior properties of 6000-25000 in the B axis.

1. An optically active film composite, for use in a transaction card, and which includes a transparent polymeric film substrate having a hard coat layer on at least one surface thereof, the hard coat layer comprising a resin binder having a thickness of less than 6 microns and a pencil hardness of at least 2H, and including 7-8% by weight of nanoparticles of Lanthanum Hexaboride.

2. A card as claimed in claim 1 wherein the hard coat layer also includes a further metallic compound absorbing light having a wavelength in the range of 1000-2500 nm.

3. A card as claimed in claim 1 wherein the composite has a VLT (visible light transmission )of about 50%, and blocks the near IR transmission to less than 10%.

4. A card as claimed in claim 1 wherein the resin binder is a uv curable acrylate resin.

5. A card as claimed in claim 1 wherein the polymeric film substrate comprises polyethyleneterephthalate (PET) film.

6. A card as claimed in claim 5 wherein the PET film may include at least one uv radiation absorbing material to block out substantially all uv radiation to less than 1% weighted UV transmission.

7. A card as claimed in claim 1 wherein the film substrate may be dyed to a desired colour.

8. A card as claimed in claim 1 wherein the film substrate has a hard coat layer on both surfaces of said film.

9. A card as claimed in claim 8 wherein the each of said hard coat layers is over layered by at least one further polymeric film layer.

10. A card as claimed in claim 9 wherein each said hard coat layer is over layered by a first layer of polymeric film by adhesive lamination, and by a second outer film layer which is hot laminated to the first layer.

11. A card as claimed in claim 8 wherein each further polymeric film layer comprises polyvinylchloride (PVC) film.

12. A card as claimed in claim 5 wherein the PET film substrate has a hard coat layer on both surfaces of said film, and each hard coat layer is over layered by a PVC film layer adhered to the hard coat layer using a pressure sensitive adhesive with a further outer PVC layer laminated over said adhered PVC film layer by hot lamination.

13. In a transaction card, an optically active film composite comprising a PET film substrate having both surfaces thereof coated with a layer of resin having a thickness of less than 6 microns, the resin including nanoparticles of Lanthanum hexaboride absorbing light having a wavelength in the range of 700-1100 nm, the composite having a VLT of about 50% and a % transmission of light at 940 nm wavelength of no more than 10%.

14. A transaction card comprising an optically active film composite including a transparent polymeric film substrate having both surfaces thereof coated with a layer of resin having a thickness of less than 6 microns and containing less than 10% by weight of nanoparticles of Lanthanum hexaboride absorbing light having a wavelength in the range of 700-1100 nm, each hard coat layer being overlayered by at least one further polymeric film layer so that each said hard coat layer is sandwiched between the substrate and said further film layer.

15. A transaction card comprising a film composite including a PET film substrate having both surfaces thereof coated with a layer of hardcoat resin, each hard coat layer being overlayered by a first PVC film layer which in turn is overlayered by a second PVC film layer so that each said hard coat layer is sandwiched between the PET substrate and said first PVC film layer.

16. A transaction card as claimed in claim 15 wherein hard coat layer contains nanoparticles of Lanthanum boride.

17. A transaction card as claimed in claim 16 wherein the first PVC layer is adhesive laminated to the adjacent hardcoat and the second PVC layer is over layer therto by hot lamination.

18. A transaction card as claimed in claim 16 wherein the PET film is dyed to a colour which reacts with any hardcoat coloration to produce a desired colour.
